(19) United States
(12) Patent Application Publication
(10) Pub. No.: US 2006/0194931 A1
(43) Pub. Date: Aug. 31, 2006

(54) Use of diazepine derivatives as latent hardening components

(75) Inventors: Stefan Ingrisch, Truchtlaching (DE); Alois Maier, Engelsberg (DE); Thomas Pfeuffer, Trostberg (DE); Norbert Steidl, Kienberg (DE); Herbert Winkelmann, Garching (DE); Fleix Gantner, Garching (DE); Andrea Gantner, Garching (DE)

Correspondence Address: ROTHWELL, FIGG, ERNST & MANBECK, P.C., 1425 K STREET, N.W., SUITE 800, WASHINGTON, DC, 20005, US

(73) Assignee: CONSTRUCTION RESEARCH & TECHNOLOGY GMBH, TROSTBERG (DE)

(21) Appl. No.: 10/555,775

(22) PCT Filed: May 5, 2004
(86) PCT No.: PCT/EP04/04780

§ 371 Date: Mar. 1, 2006

(30) Foreign Application Priority Data
May 7, 2003 (DE) 103 20 289.7

(51) Int. Cl. C08L 63/00; C08L 75/04; B32B 27/00

(52) U.S. Cl. 525/453; 525/523

(57) ABSTRACT

The invention relates to the use of diazepine derivates of general formula (I) and/or (II), wherein R¹, R², R³ and R⁵ independently represent H, C₁-C₂₀-alkyl, C₃-C₈-cycloakyl, C₆-C₁₀-aryl or alkylaryl comprising C₁-C₄-alkyl and C₆-C₁₀-aryl groups, R⁴═H, C₁-C₆-alkyl(iden), as latent hardening components for resinous substances comprising functional groups which can react with amines. Based on the particular advantages of the inventive hardening components, such as good producibility, environmentally friendly and having an excellent shelf life of the resin/hardening mixture, said diazepine derivatives are outstanding for single-componented, moisture-hardening polymer masses, which are particularly useful in the production of sealing materials, adhesives and coating materials.

The present invention relates to the use of diazepine derivatives as a latent hardener component for resins containing amine-reactive functional groups, especially polyurethane resins and polyepoxide resins.

The designation of latent hardener components is used for a hardener component which per se, on its own, is inactive and which therefore requires activation in order to become active. Moisture from the air, for example, may act as the activator. Latent hardener components of this kind are used in particular for moisture-curing polyurethane compositions in the production of sealants, adhesives, and coating materials. In accordance with the prior art a whole series of latent hardeners have already been described, but they all have the serious disadvantage that the curing reaction is accompanied by release of volatile organic compounds which either pollute the environment and/or appear problematic from the standpoint of health.

For instance, DE-A 30 19 356 describes, as hardeners for polyisocyanates, compounds which contain aldimine groups and oxazolidine groups and are prepared by a) reacting polyamines with an epoxides compound and b) subsequently cyclizing the polyamino alcohols, formed in stage a), with aldehydes. When these aldimino-oxazolidines are cured with polyisocyanates, in the presence of water or atmospheric moisture, aldehydes are eliminated which in some circumstances represent a severe odor nuisance and can therefore be used only in the outdoor area.

DE-A 36 24 924 discloses moisture-curing, storage-stable, one-component polyurethane systems which in addition to the polyurethane prepolymer include as a component essential to the invention a polyaldimine as hardener. With these polyurethane systems as well, aldehydes are eliminated in the course of curing, and so use for the interior area is ruled out from the outset. A further disadvantage associated with these polyurethane systems is the fact that the corresponding polyurethane prepolymers have a relatively high viscosity, so that diethyl malonate must be added in order to reduce the viscosity.

In accordance with DE-A 40 21 659, bisoxazolanes are recommended as hardeners for polyurethane systems, and are prepared by reacting diethanolamine with aldehydes. Although solvent-free products of low viscosity can be provided in this way, these bisoxazolanes give off two moles of aldehyde per mole of hardener in the course of the curing reaction, and such elimination is associated with the disadvantages already described above. Moreover, in EP-A 291 850, one-component poly-urethane systems are described which in addition to the polyurethane prepolymer include a latent hardener from the group consisting of oxazolidines, enamines and azomethines, preferably ketimines and/or aldimines. These compounds too give off unwanted aldehydes or ketones in the course of hydrolysis in the presence of moisture. Moreover, in order to reduce the increase in viscosity, diethyl malonate must be added to the polyurethane prepolymers or one-component polyurethane systems in an amount of up to 10% by weight.

WO 95/11933 discloses aldimine-oxazolidines. Apart from the relatively complicated preparation, the release of aldehydes in the course of the curing reaction of these compounds must be regarded as particularly disadvantageous.

EP-A 947 529, finally, discloses polyurethane prepolymers which in addition to the isocyanate groups contain latent amino groups. These polyurethane pre-polymers are prepared by addition of an amino-aldimine or of a cycloaminal with the isocyanate group of a polyurethane prepolymer. With this polyurethane system as well the elimination of benzaldehyde in the course of the curing reaction assisted by water or atmospheric moisture is unavoidable.

The object on which the present invention was based, therefore, was to provide a latent hardener component for resins containing amine-reactive functional groups that does not have the stated disadvantages of the prior art but instead does not eliminated any volatile organic compounds in the course of moisture-induced curing, possesses good performance properties, and can be prepared relatively easily and inexpensively.

This object has been achieved in accordance with the invention through the use of diazepine derivatives of the general formula (I) and/or (II) in accordance with claim 1.

It has in fact surprisingly emerged that with the hardener component proposed in accordance with the invention no organic compounds at all are eliminated in the course of the curing reaction. Furthermore, the corresponding latent hardeners can be formulated effectively with all common isocyanate-functional and epoxy-functional systems, with the corresponding hardener/resin reaction products exhibiting very good storage stability over a relatively long period, which likewise was not foreseeable.

In accordance with the invention the latent hardener component used comprises a diazepine derivative of the general formula (I) and/or (II) 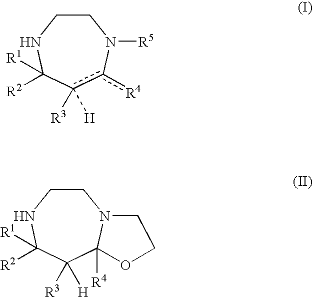
where

R¹, R², R³ and R⁵ each independently of one another are H, C₁-C₂₀ alkyl, C₃-C₈ cycloalkyl, C₆-C₁o aryl or alkyl-aryl with C₁-C₄ alkyl and C₆-C₁₀ aryl groups, and R⁴ is H, C₁-C₆ alkyl or C₁-C₆ alkylidene.

Formula (I) embraces compounds of the formulae 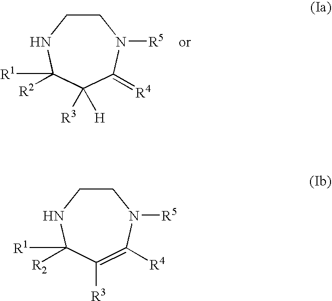
where R⁴

in formula (Ia) is C₁-C₆ alkylidene and

in formula (Ib) is H or C₁-C₆ alkyl.

Preferred alkyl radicals, which may be either linear or branched, are C₁ to C₄ alkyl groups. With regard to the cycloalkyl radicals, cyclopentyl and cyclohexyl groups, and with regard to the aryl radicals, phenyl and naphthyl groups, are regarded as being preferred.

One preferred embodiment uses, in particular, diazepine derivatives of the general formula (III) 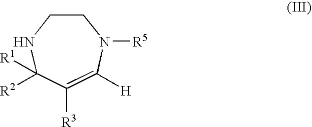
where R¹, R², R³and R⁵ are as defined above. The diazepines of the formula (III) are very easily preparable by reaction of a diamine of the formula H₂N—CH₂—CH₂—NH —R⁵ with an α,β-unsaturated aldehyde of the formula R¹ R²—C═CR³CHO in accordance with equation (A), the cyclization to the diazepine derivative taking place with elimination of water:

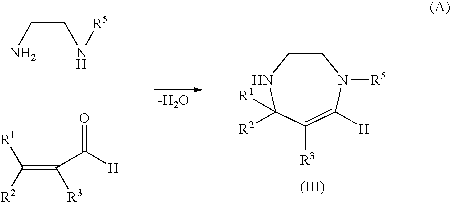

In the context of the present invention it is also possible, however, to use, as latent hardener component, diazepine derivatives of the general formula (IV) which can be prepared very readily by reacting a diamine of the formula H₂N —CH₂—CH₂—NH—R⁵ with an α,β-unsaturated ketone of the formula R¹R²C═CR³—COR⁴ (R⁴═H) in accordance with formula (B): 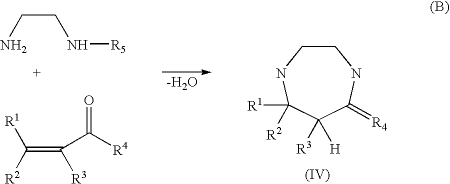
where in formula (IV) R¹, R² and R³ are as defined above and R⁴ is C₁-C₆ alkylidene.

The bicyclic diazepine derivatives of the general formula (II) proposed in accordance with the invention can be prepared by reacting a compound of the formula H₂N—CH₂—CH₂—NH—CH₂CH₂OH with an α,β-unsaturated aldehyde or ketone of the form R¹R²—C═CR³—COR⁴ in accordance with the formula (C):

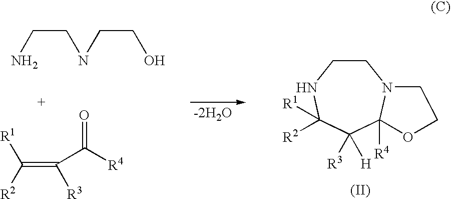

The diazepines in accordance with equations (A), (B) and (C) can be prepared by known methods in a way which is very simple from the technical standpoint (cf., for example,
a) K. J. van den Berg, L. G. J. van der Ven, A. Noomen, 4th Nürnberg Congress Internally Blocked Polyamines: Synthesis and use as crosslinker in V.O.C. compliant coatings, paper 43, Vincentz Verlag, pp. 8-12
b) Aziza Benalil, Andres Guerin, Bertrand Carboni, Michel Vaultier, J. Chem. Soc. Perkin Trans I, 1993, 1061
c) Stanislaw P. Kasprzyk, Ryszard A. Koliński, J. Pol. Chem., 1984, 58, 721
d) Douglas Lloyd, Wolfgang Scheibelein, Kálmán Hideg, J. Chem. Res. (S) 1981, 62
e) Stanislaw P. Kasprzyk, Slawomir Szymański, Pol. J. of Chem., 1979, 53, 525)

The diazepine derivatives proposed in accordance with the invention are outstandingly suitable as a latent hardener component for resins containing functional groups which are reactive toward amines.

Preferably the diazepine derivatives of the invention are used for curing polyurethane resins and/or epoxy resins.

In the context of the present invention, however, it is readily possible to use the diazepine derivatives in association with other polymer systems, such as poly-acrylates, for example, or other polymer compounds which contain at least one amine-reactive group. In one preferred embodiment in this context the diazepine derivative of the formula (I) undergoes addition via the secondary amine with the resin that is to be cured. On exposure to moisture the diazepine ring is then opened hydrolytically and the resultant secondary amine is able, finally, to react with the reactive functional groups of the resin that is to be cured.

This curing of the mixture consisting of hardener component and resin takes place preferably in the temperature range from 5 to 80° C., in particular 20 to 60° C.

The amount of hardener component used is relatively uncritical, although on economic grounds it has proven particularly advantageous to use the diazepine derivative proposed in accordance with the invention in an amount of 0.01% to 20% by weight, in particular 0.1% to 10% by weight, based on the amount of the resin that is to be cured.

In view of the particular advantages of the hardener component of the invention, such as ease of preparation, high environmental compatibility (no volatile compounds are eliminated in the course of curing), and good storage stability of the resin hardener mixtures, diazepine derivatives of the formula (I) and/or (II) are outstandingly suitable for one-component, moisture-curing polymer compositions, which are of special interest in particular for producing sealants, adhesives, and coating materials.

A description is given of the use of diazepine derivatives of the general formula (I) and/or (II) 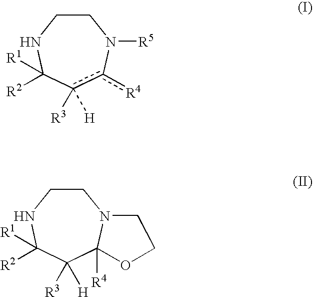
where R¹, R², R³ and R⁵ independently of one another are H, C₁-C₂₀ alkyl, C₃-C₈ cycloalkyl, C₆-C₁₀ aryl or alkyl-aryl with C₁-C₄ alkyl and C₆-C₁₀aryl groups, and R⁴ is H or C₁-C₆ alkyl(idene) as a latent hardener component for resins containing amine-reactive functional groups. In view of the particular advantages of the hardener component proposed in accordance with the invention, such as ease of preparation, high environmental compatibility, and excellent storage stability of the resin/hardener mixtures, these diazepine derivatives are outstandingly suitable for one-component, moisture-curing polymer compositions, which are of special interest in particular for producing sealants, adhesives, and coating materials.

The examples below are intended to illustrate the invention in more detail.

### EXAMPLES

### Example 1 A

### Preparation of a Diazepine Hardener Component Based on N-methylethylenediamine and Mesityl Oxide

In a reaction vessel with water separator 30 g (0.306 mol) of mesityl oxide and 21.58 g (0.291 mol) of N-methylethylenediamine are dissolved in 150 g of absolute toluene and the solution is heated to boiling. The reaction mixture is held at boiling temperature until water can no longer be removed via the water separator (theory: 5.24 g of water). Subsequently the toluene is removed completely. This gives a weakly orange, somewhat viscous liquid.

### Example 1 B

### Preparation of an NCO-Containing Prepolymer with the Diazepine Hardener Component from Example 1 A

In a reaction vessel 250 g (0.125 mol) of polypropylene glycol Dow Voranol P2000 (Dow) are maintained with 55.55 g (0.25 mol) of isophorone diisocyanate (IPDI, Desmodur® I, Bayer AG) and 0.1 g of T12-DBTL at 85° C. until the theoretical NCO content of 3.44% by weight is reached. Subsequently half of the isocyanate groups of the prepolymer are reacted at 30° C. with 21.54 g (0.125 mol) of diazepine hardener component from Example 1 A, giving a final NCO content of 1.61% by weight.

The product obtained is resinous, is transparently clear, and possesses a weak orange coloration. Drawn down on a glass plate, it cures right through without any unpleasant odor nuisance. Even in a thick-film application, curing takes place right through.

### Example 1 C

### Preparation of an NCO-Containing Prepolymer with the Diazepine Hardener Component from Example 1 A

In a reaction vessel 250 g (0.125 mol) of polycarbonate polyol Desmophen C200 (Bayer AG) are maintained with 43.54 g (0.25 mol) of tolylene diisocyanate (TDI, Desmodur® T 80, Bayer AG) and 0.1 g of T12-DBTL at 85° C. until the theoretical NCO content of 3.58% by weight is reached. Subsequently half of the isocyanate groups of the prepolymer are reacted at 30° C. with 21.54 g (0.125 mol) of diazepine. hardener component from Example 1 A, giving a final NCO content of 1.67% by weight. The other half of the methacrylate groups remain unchanged.

The product obtained is resinous, is transparently clear, and possesses a weak yellowish coloration. Drawn down on a glass plate, it cures right through without any unpleasant odor nuisance. Even in a thick-film application, curing takes place right through.

### Example 2 A

### Preparation of a Diazepine Hardener Component Based on N-ethylethylenediamine and Mesityl Oxide

In a reaction vessel with water separator 30 g (0.306 mol) of mesityl oxide and 25.66 g (0.291 mol) of N-ethylethylenediamine are dissolved in 150 g of absolute toluene and the solution is heated to boiling. The reaction mixture is held at boiling temperature until water can no longer be removed via the water separator (theory: 5.24 g of water). Subsequently the toluene is removed completely. This gives a weakly orange, somewhat viscous liquid.

### Example 2 B

### Preparation of an NCO-Containing Prepolymer with the Diazepine Hardener Component from Example 2 A

In a reaction vessel 250 g (0.125 mol) of polycarbonate polyol Desmophen C200 (Bayer AG) are maintained with 55.55 g (0.25 mol) of isophorone diisocyanate (IPDI, Desmodur® I, Bayer AG) and 0.1 g of T12-DBTL at 85° C. until the theoretical NCO content of 3.44% by weight is reached. Subsequently half of the isocyanate groups of the prepolymer are reacted at 30° C. with 23.34 g (0.125 mol) of diazepine hardener component from Example 2 A, giving a final NCO content of 1.60% by weight.

The product obtained is resinous, is transparently clear, and possesses a weak orange coloration. Drawn down on a glass plate, it cures right through without any unpleasant odor nuisance. Even in a thick-film application, curing takes place right through.

### Example 2 C

### Preparation of an NCO-Containing Prepolymer with the Diazepine Hardener Component from Example 2 A

In a reaction vessel 250 g (0.125 mol) of polycarbonate polyol Desmophen C200 (Bayer AG) are maintained with 42.05 g (0.25 mol) of 1,6-hexamethylene diisocyanate (HDI, Desmodur® H, Bayer AG) and 0.1 g of T12-DBTL at 85° C. until the theoretical NCO content of 3.60% by weight is reached. Subsequently half of the isocyanate groups of the prepolymer are reacted at 30° C. with 21.54 g (0.125 mol) of diazepine hardener component from Example 2 A, giving a final NCO content of 1.67% by weight.

The product obtained is resinous, is transparently clear, and possesses a weak yellowish coloration. Drawn down on a glass plate, it cures right through without any unpleasant odor nuisance. Even in a thick-film application, curing takes place right through.

### Example 3 A

Preparation of a Diazepine Hardener Component Based on N-methylethylenediamine and 3-methylcrotonaldehyde

In a reaction vessel with water separator 30 g (0.357 mol) of 3-methylcrotonaldehyde and 25.18 g (0.340 mol) of N-methylethylenediamine are dissolved in 150 g of absolute toluene and the solution is heated to boiling. The reaction mixture is held at boiling temperature until water can no longer be removed via the water separator (theory: 6.11 g of water). Subsequently the toluene is removed completely. This gives a weakly reddish, somewhat viscous liquid.

### Example 3 B

Preparation of an NCO-Containing Prepolymer with the Diazepine Hardener Component from Example 3 A

In a reaction vessel 250 g (0.123 mol) of polyester polyol Bester 42 H (Poliolchimica) are maintained with 54.86 g (0.247 mol) of isophorone diisocyanate (IPDI, Desmodur® I, Bayer AG) and 0.1 g of T12-DBTL at 85° C. until the theoretical NCO content of 3.40% by weight is reached. Subsequently half of the isocyanate groups of the prepolymer are reacted at 30° C. with 17.28 g (0.123 mol) of diazepine hardener component from Example 3 A, giving a final NCO content of 1.61% by weight.

The product obtained is resinous, is transparently clear, and possesses a weak reddish coloration. Drawn down on a glass plate, it cures right through without any unpleasant odor nuisance. Even in a thick-film application, curing takes place right through.

### Example 3 C

### Preparation of an NCO-Containing Prepolymer with the Diazepine Hardener Component from Example 3 A

In a reaction vessel 250 g (0.123 mol) of polyester polyol Bester 42 H (Poliolchimica) are maintained with 60.32 g (0.247 mol) of m-tetramethylxylylene diisocyanate (TMXDI®, Cytec) and 0.1 g of T12-DBTL at 85° C. until the theoretical NCO content of 3.34% by weight is reached. Subsequently half of the isocyanate groups of the prepolymer are reacted at 30° C. with 17.33 g (0.123 mol) of diazepine hardener component from Example 3 A, giving a final NCO content of 1.58% by weight.

The product obtained is resinous, is transparently clear, and possesses a weak reddish coloration. Drawn down on a glass plate, it cures right through without any unpleasant odor nuisance. Even in a thick-film application, curing takes place right through.

### Example 4 A

### Preparation of a Diazepine Hardener Component Based on N-ethylethylenediamine and 3-methylcrotonaldehyde

In a reaction vessel with water separator 30 g (0.357 mol) of 3-methylcrotonaldehyde and 29.94 g (0.340 mol) of N-ethylethylenediamine are dissolved in 150 g of absolute toluene and the solution is heated to boiling. The reaction mixture is held at boiling temperature until water can no longer be removed via the water separator (theory: 6.11 g of water). Subsequently the toluene is removed completely. This gives a weakly reddish, somewhat viscous liquid.

### Example 4 B

### Preparation of an NCO-Containing Prepolymer with the Diazepine Hardener Component from Example 4 A

In a reaction vessel 250 g (0.083 mol) of polypropylene glycol Dow Voranol P3000 (Dow) are maintained with 37.03 g (0.167 mol) of isophorone diisocyanate (IPDI, Desmodur® I, Bayer AG) and 0.1 g of T12-DBTL at 85° C. until the theoretical NCO content of 2.44% by weight is reached. Subsequently half of the isocyanate groups of the prepolymer are reacted at 30° C. with 12.88 g (0.083 mol) of diazepine hardener component from Example 4 A, giving a final NCO content of 1.17% by weight.

The product obtained is resinous, is transparently clear, and possesses a weak reddish coloration. Drawn down on a glass plate, it cures right through without any unpleasant odor nuisance. Even in a thick-film application, curing takes place right through.

### Example 4 C

### Preparation of an NCO-containing prepolymer with the diazepine hardener component from Example 4 A

In a reaction vessel 250 g (0.063 mol) of polypropylene glycol Dow Voranol P4000 (Dow) are maintained with 32.79 g (0.125 mol) of dicyclohexylmethane diisocyanate (H₁₂MDI, Desmodur® W, Bayer AG) and 0.1 g of T12-DBTL at 85° C. until the theoretical NCO content of 1.86% by weight is reached. Subsequently half of the isocyanate groups of the prepolymer are reacted at 30° C. with 9.66 g (0.063 mol) of diazepine hardener component from Example 4 A, giving a final NCO content of 0.90% by weight.

The product obtained is resinous, is transparently clear, and possesses a weak reddish coloration. Drawn down on a glass plate, it cures right through without any unpleasant odor nuisance. Even in a thick-film application, curing takes place right through.

### Example 5 A

### Preparation of a Diazepine Hardener Component Based on N-(2-hydroxyethyl)ethylenediamine and Mesityl Oxide

In a reaction vessel with water separator 30 g (0.306 mol) of mesityl oxide and 30.32 g (0.291 mol) of N-(2-hydroxyethyl)ethylenediamine are dissolved in 150 g of absolute toluene and the solution is heated to boiling. The reaction mixture is held at boiling temperature until water can no longer be removed via the water separator (theory: 5.24 g of water). Subsequently the toluene is removed completely. This gives an orange, somewhat viscous liquid.

### Example 5 B

### Preparation of an NCO-containing prepolymer with the diazepine hardener component from Example 5 A

In a reaction vessel 250 g (0.25 mol) of polypropylene glycol Dow Voranol P1010 (Dow) are maintained with 87.08 g (0.50 mol) of tolylene diisocyanate (TDI, Desmodur® T 80, Bayer AG) and 0.1 g of T12-DBTL at 85° C. until the theoretical NCO content of 6.23% by weight is reached. Subsequently the free isocyanate groups of the prepolymer are reacted at 30° C. with 15.36 g (0.083 mol) of diazepine hardener component from Example 5 A, giving an NCO content of 2.98% by weight.

The product obtained is resinous, is transparently clear, and possesses a weak orange coloration. Drawn down on a glass plate, it cures right through without any unpleasant odor nuisance. Even in a thick-film application, curing takes place right through.

### Example 5 C

### Preparation of an NCO-Containing Prepolymer with the Diazepine Hardener Component from Example 5 A

In a reaction vessel 250 g (0.123 mol) of polyester polyol Bester 42 H (Poliolchimica) are maintained with 41.53 g (0.247 mol) of 1,6-hexamethylene diisocyanate (HDI, Desmodur® H, Bayer AG) and 0.1 g of T12-DBTL at 85° C. until the theoretical NCO content of 3.56% by weight is reached. Subsequently the free isocyanate groups of the prepolymer are reacted at 30° C. with 7.58 g (0.041 mol) of diazepine hardener component from Example 5 A, giving an NCO content of 1.73% by weight.

The product obtained is resinous, is transparently clear, and possesses a weak orange coloration. Drawn down on a glass plate, it cures right through without any unpleasant odor nuisance. Even in a thick-film application, curing takes place right through.

### Example 6

### Storage Stability Test

The mixtures of prepolymers and latent hardeners prepared in accordance with Examples 1 to 5 are subjected to storage in closed vessels at room temperature (20-25° C.), the results obtained being as follows:

After a storage time of 12 months at a temperature between 20-25° C. in lightfast and airtight vessels, no notable change in color was found for any of the examples. The increase in viscosity over this period was very low (increase by a factor in the range of 1.1-1.3 relative to the initial viscosity) and exhibited no effects at all on the curing or the processing properties.

1. (canceled)

2. The use of claim 8, characterized in that diazepine derivatives of the formula (III) 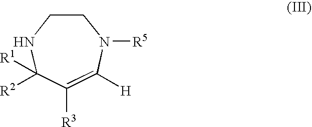
are used where R¹, R², R³, and R⁵ are as defined above.

3. A method of curing resins containing amine-reactive functional groups comprising curing the resins in the presence of at least one diazepine derivatives of the formulae (I) and/or (II 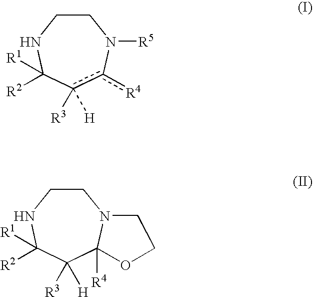
where
R¹, R² and R³ independently of one another are H, C₁-C₂₀ alkyl, C₃-C₈ cycloalkyl, C₆-C₁₀ aryl or alkylaryl with C₁-C₄ alkyl and C₆-C₁₀ aryl groups, R⁵ is C₁ -C₂₀ alkyl, C₃-C₈ cycloalkyl, C₆-C₁₀ aryl or alkylaryl with C₁-C₄ alkyl and C₆-C₁₀ aryl groups, R⁴ is H, C₁-C₆ alkyl or C₁-C₆ alkylidene.

4. The method of claim 3, characterized in that the diazepine derivative of the formulae (I) and/or (II) is added via the secondary amine with the resin that is to be cured, the diazepine ring added onto the resin is opened hydrolytically by exposure to moisture, and the resultant secondary amine is reacted with the reactive functional groups of the resin that is to be cured.

5. The method of claim 3, characterized in that polyurethanes or polyepoxides and also mixtures thereof are used as the resin that is to be cured.

6. The method of claim 3, characterized in that the hardener component is used in an amount of 0.01 to 20% by weight, in particular 0.1 to 10% by weight, based on the amount of the resin that is to be cured.

7. The method of claim 3, characterized in that the mixture consisting of hardener component and resin is cured at a temperature of 5 to 80° C.

8. The use of diazepine derivatives of the general formula (I) and/or (II) 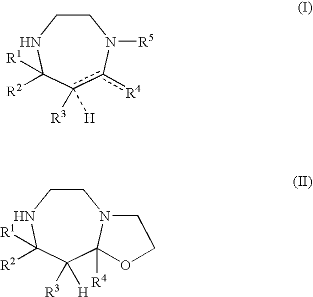
where
R¹, R² and R³ independently of one another are H, C₁-C₂₀ alkyl, C₃-C₈ cycloalkyl, C₆-C₁₀ aryl or alkylaryl with C₁-C₄ alkyl and C₆-C₁₀ aryl groups, R⁵ is C¹-C₂₀ alkyl, C₃-C₈ cycloalkyl, C₆-C₁₀ aryl or alkylaryl with C₁-C₄ alkyl and C₆-C₁₀ aryl groups, R⁴ is H, C₁-C₆ alkyl or C₁-C₆ alkylidene as a latent hardener component for resins containing amine-reactive functional groups.
